(19) United States
(12) Patent Application Publication
(10) Pub. No.: US 2025/0116203 A1
(43) Pub. Date: Apr. 10, 2025

(54) TURBOMACHINE ASSEMBLY COMPRISING A HALF-SHELL CASING BEARING VARIABLE-PITCH INLET STATOR VANES

(71) Applicant: Safran Aircraft Engines, PARIS (FR)

(72) Inventors: Olivier BELMONTE, MOISSY-CRAMAYEL (FR); Julien Fabien Patrick BECOULET, MOISSY-CRAMAYEL (FR)

(73) Assignee: Safran Aircraft Engines, PARIS (FR)

(21) Appl. No.: 18/833,280

(22) PCT Filed: Feb. 14, 2023
(86) PCT No.: PCT/FR2023/050194

§ 371 Date: Jul. 25, 2024

(30) Foreign Application Priority Data
Feb. 14, 2022 (FR) 2201266

(51) Int. Cl. F01D 17/14; F01D 25/26

(52) U.S. Cl. CPC F01D 17/14; F01D 25/26; F05D 2220/32; F05D 2240/12; F05D 2240/14

(57) ABSTRACT

The present invention relates to an assembly (12) for a turbomachine, comprising: —an outer casing (15) made of half-shells; —an inner casing (14); —a plurality of guide vanes (13) mounted between the outer casing (15) and the inner casing (14), —a structural casing comprising a flange (23) which is radially inside the inner casing (14); and—a system (24) for blocking the inner casing (14) on the structural casing, comprising a generally annular tab (25) fixed to one of the inner casing (14) and the structural casing and a complementary chute (26) fixed to the other of the inner casing (14) and the structural casing, the chute (26) being configured to receive the tab (25) and to block it along the axis (X) with respect to the structural casing.

### TECHNICAL FIELD

The present disclosure generally relates to the field of turbomachines comprising in particular inlet guide vanes with variable setting, and more particularly the maintenance and inspection of such turbomachines.

### STATE OF THE ART

A turbofan engine generally comprises, from upstream to downstream in the gas flow direction, a fan, a primary annular flow space and a secondary annular flow space which extends around the primary flow. The air mass sucked in by the fan is therefore divided into a primary stream which circulates in the primary flow space, and a secondary stream which is concentric with the primary stream and circulates in the secondary flow space.

The turbomachine can further comprise an inlet guide vane (IGV) wheel (stator) with variable setting, located immediately upstream of a booster (or low-pressure compressor), at the entrance to the primary flow space. The mounting of the IGVs is conventionally carried out by individually mounting each IGV in an outer casing of the turbomachine and by fixing this outer casing to a structural casing, typically using a clamp and nuts. The inner part of the turbomachine is not yet in place. Upstream and downstream parts of the inner casing of the turbomachine are then placed on either side of the foot of the IGVs in order to reconstitute a complete inner casing “supporting” the IGVs radially inward. This entire inner casing is then fixed to the adjacent structural casing, typically an intermediate casing (or inter-compressor casing), via screws.

Thus, to access the IGVs or inspect the rotor blade assembly downstream of the IGV (generally a booster stage), it is necessary to separate the structural casing from the entire rotor stage that follows it, in particular to be able to access the screws of the inner casing. However, such dismounting is long and difficult, particularly in the engines comprising a reduction mechanism between the low-pressure shaft and the fan, because their architecture is very complex.

### DISCLOSURE

One aim is to overcome the aforementioned drawbacks, by proposing a turbomachine comprising a row of IGVs and, optionally, a reduction mechanism between the low-pressure shaft and the fan, which can be easily dismounted and remounted, in particular during a maintenance or inspection operation in order to optimize the operational costs.

For this purpose, according to a first aspect, there is proposed an assembly for a turbomachine is proposed, comprising:
an outer casing made of half-shells comprising a first and a second hemispherical outer shroud;
an inner casing located radially inside the outer casing and comprising a first and a second hemispherical inner shroud;
a plurality of guide vanes mounted between the outer casing and the inner casing,
a structural casing comprising a generally cylindrical flange located radially inside the inner casing and having symmetry of revolution with respect to an axis; and
a system for blocking the inner casing on the structural casing, the blocking system comprising a generally annular tab fixed on one among the inner casing and the structural casing and a complementary chute fixed on the other among the inner casing and the structural casing, the chute being configured to receive the tab and block it along the axis relative to the structural casing.

Some preferred but non-limiting characteristics of the assembly for a turbomachine according to the first aspect are as follows, taken individually or in combination:
the tab is monolithic with the inner casing and the chute is monolithic with the structural casing;
the chute has a downstream section and an upstream section separated by a bottom, the downstream section being inclined relative to a plane normal to the axis and the tab has an inclined downstream face configured to bear against the downstream section of the chute;
the tab has an upstream face configured to bear against an upstream section of the chute, the upstream section and the upstream face each being parallel to a plane normal to the axis;
the upstream face has an outer radial portion configured to bear against the upstream section of the chute and an inner radial portion forming an annular clearance extending at a distance from the outer radial portion;
the chute further comprises a bottom connected to the upstream section and/or to the downstream section by a curved surface; and/or
the inner casing further comprises a first and a second hemispherical downstream inner shroud extending immediately downstream of the first and second inner shrouds, a base of the guide vanes being mounted between the first and second inner shrouds and the first and second downstream inner shrouds.

According to a second aspect, the present disclosure proposes a turbomachine comprising an assembly according to the first aspect.

Some preferred but non-limiting characteristics of the turbomachine according to the second aspect are as follows, taken individually or in combination:
the turbomachine further comprises a rotor mounted immediately downstream of the assembly, for example a booster; and/or
the turbomachine further comprises a turbine configured to drive a fan via a reduction mechanism, the turbine further being configured to drive the rotor.

According to a third aspect, the present disclosure proposes an aircraft comprising at least one turbomachine according to the second aspect.

### DESCRIPTION OF THE FIGURES

Other characteristics, aims and advantages will emerge from the following description which is purely illustrative and not limiting and which should be read in relation to the appended drawings in which:

FIG. 1 is an axial sectional view of a turbomachine assembly in accordance with one embodiment;

FIG. 2 is a partial perspective view of the turbomachine assembly of FIG. 1;

FIG. 3 is a detailed view of the blocking system of the turbomachine assembly of FIG. 1;

FIG. 4 is a front view of the half-shells of the turbomachine assembly of FIG. 1 being assembled with the structural casing; and

FIG. 5 is a simplified sectional view of one example of a turbomachine which may comprise a turbomachine assembly as proposed.

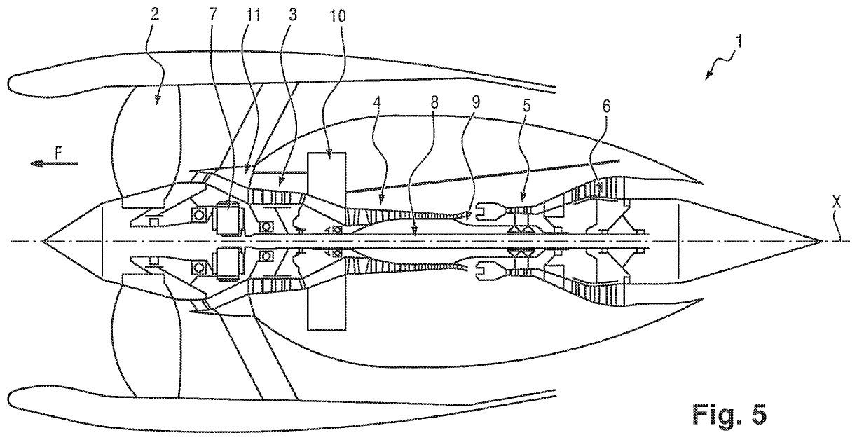

In all the figures, similar elements bear identical references.

### DETAILED DESCRIPTION

A turbofan engine 1 comprises, as indicated above, a fan 2, a primary annular flow space and a secondary annular flow space around the primary flow. The fan 2 (or propeller) can be ducted and housed in a fan casing or, as a variant, unducted of the USF (Unducted Single Fan 2) type. The fan vanes can be fixed or have a variable setting, the setting being adjusted according to the flight phases by a pitch change mechanism.

The primary flow space passes through a primary spool comprising one or several compressor stages, for example a low-pressure compressor (or booster 3) and a high-pressure compressor 4, a combustion chamber, one or several turbine stages, for example a high-pressure turbine 5 and a low-pressure turbine 6, and a gas exhaust nozzle. Typically, the high-pressure turbine 5 drives in rotation the high-pressure compressor 4 via a first shaft, called high-pressure shaft 9, while the low-pressure turbine 6 drives in rotation the booster 3 and the fan 2 via a second shaft, called low-pressure shaft 8.

In order to improve the propulsive efficiency of the turbomachine 1 and to reduce its specific consumption as well as the noise emitted by the fan 2, turbomachines 1 have been proposed having a bypass ratio, that is to say a high ratio between the flow rate of the secondary stream and that of the primary stream. By “high bypass ratio”, it will be understood here a bypass ratio greater than 10, for example comprised between 12 and 18. To achieve such bypass ratios, the fan 2 is decoupled from the low-pressure turbine 6, thus making it possible to optimize independently their respective rotation speed. For example, the decoupling can be carried out using a reduction gear such as an epicyclic or planetary reduction mechanism 7, placed between the upstream end of the low-pressure shaft 8 and the fan 2. The fan 2 is then driven by the low-pressure shaft 8 via the reduction mechanism 7 and an additional shaft, called fan shaft 2, which is fixed between the reduction mechanism 7 and the fan disk 2. This decoupling thus makes it possible to reduce the rotation speed and the pressure ratio of the fan 2 and to increase the power extracted by the low-pressure turbine 6.

In the turbofan engines 1, a large part of the thrust is produced by the fan 2. The axial forces applied to the fan blades are transmitted by a thrust bearing towards the fixed parts of the engine, then raised towards the suspensions of the engine via the intermediate casing 10 (or inter-compressor casing).

In a turbomachine 1 comprising a reduction mechanism 7 between the low-pressure shaft 8 and the fan shaft 2, the path of the forces is arranged differently. Indeed, the engine comprises, in addition to the intermediate casing 10, an inlet casing 11 located between the fan 2 and the booster 3 in order to support the weight of the reduction mechanism 7 and of the bearings. The inlet casing 11 is thus designed to directly support the reduction mechanism 7 and the bearings supporting the fan shaft. In such architecture, the axial forces thus pass through the inlet casing 11 and the intermediate casing 10.

The turbomachine 1 further comprises an inlet guide vane wheel 12 (IGV wheel 12) (stator) located immediately upstream of the booster 3, at the entrance to the primary flow space.

The IGV wheel 12 comprises a plurality of IGVs 13, an outer casing 15 and an inner casing 14, the IGVs 13 being mounted between the inner casing 14 and the outer casing 15 via pivot connections 16. The outer casing 15 is a half-shell casing, that is to say it comprises a first and a second hemispherical outer shroud 17, 18 which are connected so as to form the outer casing 15. The inner casing 14 is also a half-shell casing and comprises two hemispherical upstream inner shrouds 19, 20 and two hemispherical downstream inner shrouds 21, 22 connected two by two so as to form an upstream shell and a downstream shell of the inner casing 14. The upstream shrouds and the downstream shrouds 21, 22 extend on either side of the bases of the IGVs 13 and are fixed together by mechanical connections, typically bolted connections.

Each hemispherical shroud 19-22 is preferably monolithic.

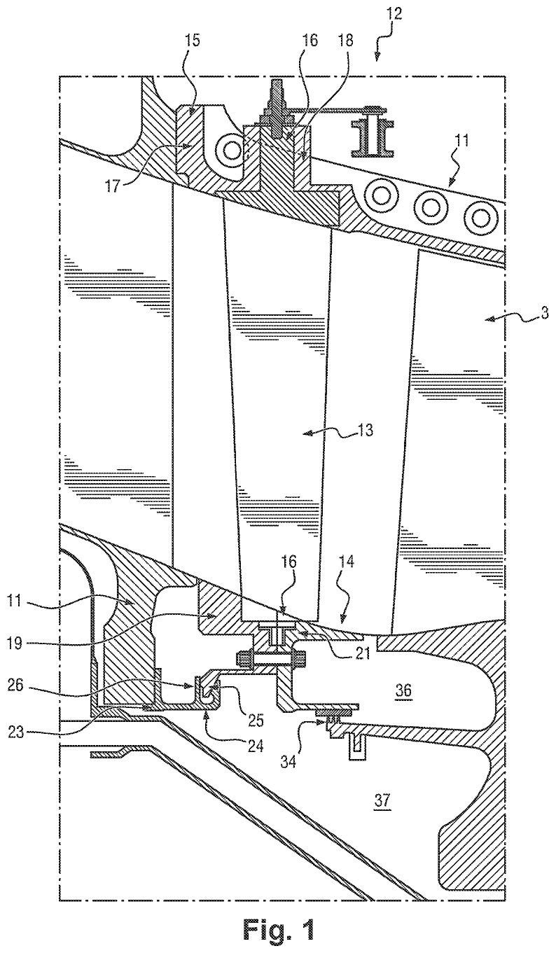

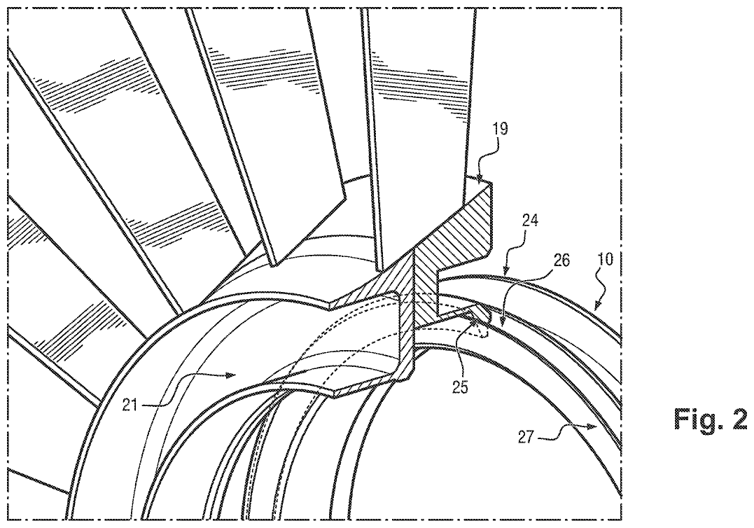

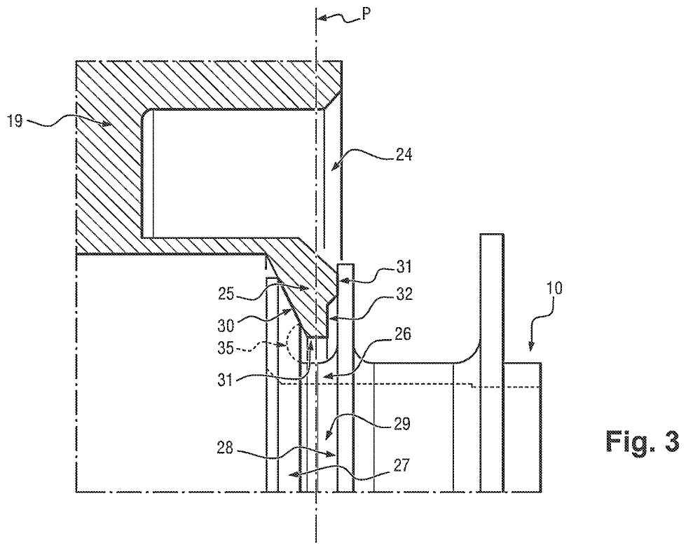

The turbomachine 1 further comprises a structural casing 10, 11 comprising an annular flange 23 extending radially inside the inner casing 14. The structural casing 10, 11 can in particular correspond to the inlet casing 11 or to the intermediate casing 10, depending on the configuration of the turbomachine 1. In the example illustrated in FIGS. 1 to 4 for example, the flange 23 and the outer casing 14 are fixed on the inlet casing 10.

In the following, the upstream and downstream are defined in relation to the normal gas flow direction through the turbomachine 1. Moreover, the axis of revolution of the annular flange 23 of the structural casing 10, 11 is called axis X. The axial direction corresponds to the direction of the axis X and a radial direction is a direction perpendicular to this axis X and passing through it. Unless otherwise specified, inner (respectively, internal) and outer (respectively, external), respectively, are used with reference to a radial direction so that the inner part or face of an element is closer to the axis X than the outer part or face of the same element. Finally, a casing of the turbomachine 1 used for the load transfer, that is to say through which forces in particular axial and radial forces pass (such as the loads of the loads of the bearings supporting the shafts towards the suspensions of the turbomachine) will be referred to as “structural casing”. It may for example be the intermediate casing 10 or, in the case of a turbomachine 1 comprising a reduction mechanism 7, the inlet casing 11 or the intermediate casing 10. On the other hand, the inner casing 14 and the outer casing 15 both have a function of supporting the IGVs 13 and delimiting the flowpath within the IGV wheel 13. On the other hand, they do not form a structural casing within the meaning of the patent.

The IGVs 13 are fixed in the sense that they are fixed in rotation relative to the inner casing 14 and to the outer casing 15 about the axis X. The IGVs 13, on the other hand, are variable setting IGVs and are mounted on the inner casing 14 and the outer casing 15 via pivot connections 16 in order to be able to adjust their angle of incidence relative to the stream as a function of the flight phases of the turbomachine 1. The timing axis of the IGVs 13 is substantially radial to the axis X.

For this purpose, the IGVs 13 each comprise a head and a base fixed to the outer casing 15 and the inner casing 14, respectively, via pivot connections 16 so as to allow the rotation of the IGVs 13 about their setting axis. The turbomachine 1 further comprises a control kinematics that can be mounted on the outer casing 15 and configured to control the setting angle of the corresponding pivot connection 16 of the IGVs 13.

In order to fix the IGVs 13 to the structural casing 10, 11, the turbomachine 1 further comprises a blocking system 24 of the inner casing 14 on the structural casing 10, 11 comprising a tab 25 fixed to one among the inner casing 14 and the structural casing 10, 11 and a complementary chute 26 fixed to the other among the inner casing 14 and the structural casing 10, 11. The chute 26 is configured to receive the tab 25 and block it axially (i.e. along the axis X) relative to the structural casing 10, 11.

The IGV wheel 13 is therefore formed of two parts or half-shells 13a, 13b, each half-shell 13a, 13b of the IGV wheel 13 comprising an outer shroud 17, 18, a set of IGV 13, an upstream inner shroud 19, 20 and a downstream inner shroud 21, 22. A first half-shell 13a of the IGV wheel 13 can then be mounted in the turbomachine 1 by placing the tab 25 in the chute 26, so as to axially block the half-shell relative to the structural casing 10, 11. The other half-shell 13b of the IGV wheel 13 can then be fixed in a similar manner, by placing the tab 25 in the corresponding chute 26. Then the two half-shells 13a, 13b can be secured by fixing their outer shell 17, 18 to the structural casing 10, 11, for example using bolted connections.

The dismounting of the IGV wheel 13 can be carried out in a similar manner, by dismounting the outer casing 15, for example by disengaging the bolted connections. It is then sufficient to remove the tab 25 from the corresponding chute 26 to separate the two half-shells 13a, 13b of the IGV wheel 13 from the structural casing 10, 11. This dismounting is particularly easy insofar as it is not necessary to dismount fixing means placed at the level of the inner casing 14 that would otherwise be difficult to access.

In the following, the assembly will be described in the case where the tab 25 is monolithic with the inner casing 14 and the chute 26 is secured to the structural casing 10, 11, typically monolithic with the flange 23. This embodiment indeed facilitates the mounting of the IGV wheel 13 on the structural casing 10, 11 and further ensures better radial retention of the IGV wheel 13. This is however not limiting, the tab 25 being able to be monolithic with the structural casing 10, 11 and the chute 26 monolithic with the inner casing 14.

The tab 25 is generally cylindrical about the axis X, preferably annular. The tab 25 being monolithic with the inner casing 14, it is made in two parts: a first part fixed to one of the upstream shrouds 19 and a second part fixed to the other of the upstream shrouds 20. Each part of the tab 25 can be substantially continuous about the axis X, or as a variant comprise disjointed ring sectors. For convenience, however, in what follows, reference will be made to “the tab 25”, even if it is in several parts.

The chute 26 has a complementary shape to the tab 25 and is generally cylindrical about the axis X. The chute 26 can be substantially continuous over its entire periphery or as a variant comprise disjointed chute sectors 26.

The tab 25 extends radially inward from the upstream inner shrouds 19, 20 of the inner casing 14. In one embodiment, the tab 25 extends from an upstream end of the upstream inner shrouds 19, 20. The chute 26 extends radially outwardly of the flange 23, facing the tab 25.

The flange 23 can comprise an annular sheet fixed to the structural casing 10, 11 upstream of the inner casing 14, typically from a downstream end of the annular sheet. The chute 26 extends for example from a downstream radial end of the flange 23.

The chute 26 comprises a downstream section 27, an upstream section 28 and a bottom 29 connecting the downstream section 27 and the upstream section 28. The side of the chute 26 which is opposite to the bottom 29 is open in order to allow the introduction of the tab 25 in the chute 26. The bottom 29 is disposed radially inward relative to the upstream and downstream sections 28, 27 of the chute 26. The tab 25 for its part has a downstream face 30 configured to abut against the downstream section 27, an upstream face 31 configured to abut against the upstream section 28, and a top 32 connecting the downstream face 30 and the upstream face 31 and configured to extend facing the bottom 29 of the chute 26. The tab 25 and the chute 26 are dimensioned so that the top 32 of the tab 25 remains at a distance from the bottom 29 of the chute 26 and therefore does not come into contact with the chute 26, even when the tab 25 is engaged in the chute 26.

In order to effectively block the inner casing 14 relative to the structural casing 10, 11 along the axial direction, the downstream section 27 and the downstream face 30 are inclined relative to a plane P normal to the axis X passing through the center of the chute 26. Particularly, the downstream section 27 is inclined in the direction of the bottom 29 so as to guide the downstream face 30 towards the bottom 29 and the upstream face 31 of the chute 26. The angle formed between the downstream section 27 and the plane P normal to the axis X can be comprised between 15° and 45°.

The upstream section 28 of the chute 26 and the upstream face 31 of the tab 25 are substantially parallel to the plane P normal to the axis X. They are therefore radial to the axis X.

The tab 25 is then cornered in the chute 26, which makes it possible to effectively block the inner casing 14 relative to the structural casing 10, 11 along the axial direction. This axial bearing is particularly relevant in the event of pumping or adjustment of the dimensions, insofar as it ensures axial strength of the IGV wheel 13 despite the application of axial forces to the IGV wheel 13. The radial blocking for its part is done on the one hand by the abutment formed by the downstream section 27 and on the other hand by the fixing of the head of the IGVs 13 in the outer casing 15.

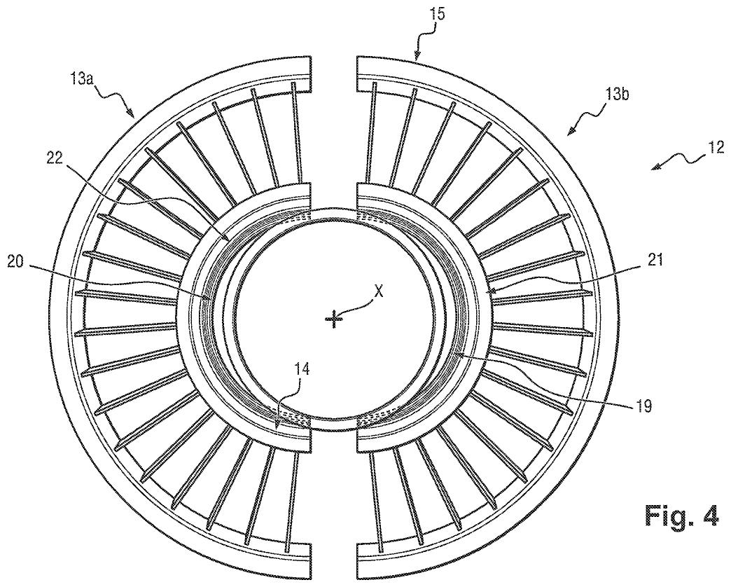

Optionally, in the downstream part, the tab 25 can comprise an upper part comprising the substantially radial upstream face 31 and configured to come into surface contact with the radial section, and a lower part in which a groove 33 extending to the top 32 of the tab 25 (see FIG. 4) is formed. The bottom of the groove 33 therefore extends at a distance from the upstream section 28. The groove 33 then forms a clearance in order to prevent the tab 25 from coming into contact with the bottom 29 of the chute 26, and more specifically with the downstream connection radius between the bottom 29 and the upstream section 28 of the chute 26.

In one variant of embodiment which can be combined with the previous option, the downstream section 27 of the chute 26 can comprise an upper part comprising the inclined portion configured to come into surface contact with the downstream face and a lower part in which a groove 35 extending to the bottom 29 is formed so as to form a clearance to prevent the tab 25 from coming into contact with the bottom 29 of the chute 26, and more specifically with the downstream connection radius between the bottom 29 and the downstream section 27 of the chute 26.

Where appropriate, the bottom 29 of the chute 26 and the upstream section 28 can be connected by a curved surface. Optionally, the bottom 29 of the chute 26 can also be connected to the downstream section 27 by a curved surface.

The downstream inner shrouds 21, 22 of the inner casing 14 are fixed to the upstream inner shrouds 19, 20 via usual fixing means, typically bolted connections. The inner pivot connections 16 of the IGVs 13 are also mounted between the upstream 19, 20 and downstream 21, 22 inner shrouds of the inner casing 14.

Thus, the dismounting of the IGV wheel 13 into two half-shells 13a, 13b makes it possible to simultaneously remove the outer casing 15, the inner casing 14 (upstream 19, 20 and downstream 21, 22 inner shrouds), the IGVs 13 and their pivot connections 16 in a simple and rapid manner. Each IGV 13 of the wheel can also be replaced or repaired individually. Moreover, the withdrawal of the IGV wheel 13 makes it possible to create access to the rotor stage immediately downstream, typically to the booster 3, in order to allow its inspection and/or repair. Particularly, the immediately downstream rotor stage remains in place in the turbomachine 1, so that it remains possible to rotate it during the inspection and to check its correct operation.

The turbomachine 1 can further comprise a sealing between the downstream inner shrouds 21, 22 of the inner casing 14 and the immediately downstream stage, typically a rotor stage, in order to limit the air transfer between a first cavity 36 located between the IGV wheel 12 and the first compressor rotor in contact with the primary air flowpath, and a second inner cavity 37 to the turbomachine. The sealing 34 can comprise a labyrinth seal, mounted on an axial clamp extending downstream from the downstream inner shrouds 21, 22 and an associated labyrinth seal mounted on an axial clamp extending upstream from a hub of the rotor stage. The rotor stage can for example comprise a stage of the booster 3.

1. An assembly for a turbomachine comprising:
an outer casing made of half-shells, the outer casing comprising a first and a second hemispherical outer shroud;
an inner casing located radially inside the outer casing and comprising a first and a second hemispherical inner shroud;
a plurality of guide vanes mounted between the outer casing and the inner casing;
a structural casing comprising a generally cylindrical flange located radially inside the inner casing and having a symmetry of revolution with respect to an axis; and
a system for blocking the inner casing on the structural casing, the blocking system comprising a generally annular tab fixed on one among the inner casing and the structural casing and a complementary chute fixed on the other among the inner casing and the structural casing, the chute being configured to receive the tab and block it along the axis relative to the structural casing.

2. The assembly for a turbomachine according to claim 1, wherein the tab is monolithic with the inner casing and the chute is monolithic with the structural casing.

3. The assembly for a turbomachine according to claim 1, wherein:
the chute has a downstream section and an upstream section separated by a bottom, the downstream section being inclined relative to a plane normal to the axis; and
the tab has an inclined downstream face configured to bear against the downstream section of the chute.

4. The assembly for a turbomachine according to claim 1, wherein the tab has an upstream face configured to bear against an upstream section of the chute, the upstream section and the upstream face each being parallel to a plane normal to the axis.

5. The assembly for a turbomachine according to claim 4, wherein the upstream face has an outer radial portion configured to bear against the upstream section of the chute and an inner radial portion forming an annular clearance extending at a distance from the outer radial portion.

6. The assembly for a turbomachine according to claim 5, wherein the chute further comprises a bottom connected to the upstream section and/or to the downstream section by a curved surface.

7. The assembly for a turbomachine according to claim 1, wherein the inner casing further comprises a first and a second hemispherical downstream inner shroud extending immediately downstream of the first and second inner shrouds, a base of the guide vanes being mounted between the first and second inner shrouds and the first and second downstream inner shrouds.

8. A turbomachine comprising an assembly according to claim 7.

9. The turbomachine according to claim 8 further comprising a rotor mounted immediately downstream of the assembly, for example a booster.

10. The turbomachine according to claim 8, further comprising a turbine configured to drive a fan via a reduction mechanism, the turbine further being configured to drive the rotor.
